(19) United States
(12) Patent Application Publication
(10) Pub. No.: US 2025/0154002 A1
(43) Pub. Date: May 15, 2025

(54) METHOD FOR CONTINUOUS PRODUCTION OF HYDROGEN BY MAGNESIUM-CONTAINING BASE MATERIALS

(71) Applicant: GRÜNLAND Innovations GmbH, Ried im Traunkreis (AT)

(72) Inventors: Daniel FAHRNER, Wien (AT); Marlene MÜHLBÖCK, Ohlsdorf (AT)

(73) Assignee: GRÜNLAND Innovations GmbH, Ried im Traunkreis (AT)

(21) Appl. No.: 18/841,097

(22) PCT Filed: Mar. 15, 2023
(86) PCT No.: PCT/EP2023/056616

§ 371 Date: Aug. 23, 2024

(30) Foreign Application Priority Data
Mar. 16, 2022 (EP) 22162551.0

(51) Int. Cl. C01B 3/08

(52) U.S. Cl. CPC C01B 3/08

(57) ABSTRACT

A method for producing hydrogen, includes the steps of: providing a base material including magnesium; providing a carrier fluid, in particular water; providing a pH-lowering liquid; bringing together the base material and the carrier fluid in a suspension container to form a suspension; supplying the pH-lowering liquid to a reactor; continuously supplying the suspension to the reactor; discharging the hydrogen produced in the reactor in a reaction of the base material and the pH-lowering liquid from the reactor. Further, a corresponding device produces hydrogen.

The invention relates to a method and a device for producing hydrogen (H₂).

Hydrogen, which has been used for several decades in the industrial sector to generate heat to reduce CO₂ emissions and can also be used in the mobile sector to reduce emissions, should also be generated in a low-emission way. In the chemical production of hydrogen by the process of hydrolysis, it is known that a base material, which is mixed with a carrier fluid (usually water) or a pH-lowering liquid, reacts strongly exothermically to form hydrogen and a product, which is dependent on the reactant base material. The reactant base material can also consist of secondary raw materials obtained in the course of the magnesium processing industry, or from other materials that are not industrially reusable, such as residual materials, intermediates or waste from industry.

The reactant pH-lowering fluid is in particular a water-acid mixture, wherein organic or inorganic acids can be used. Lowering the pH in the liquid is essential for the reaction kinetics of the exothermic reaction.

In general, the reaction can be described as follows: Base material+pH-lowering liquid=residue+hydrogen+energy.

In the hydrolysis reaction with magnesium as the base material, energy in the form of heat is released, the reaction enthalpy ΔH_{R} corresponding to around 277 kJ/mol. It is known to carry out this reaction in a round-bottomed flask with a liquid inlet, a certain amount of reagant being supplied once or batchwise. Such methods are described, for example, in Ouyang, L. et al. “Enhanced Hydrogen Generation Properties of MgH2-Based Hydrides by Breaking the Magnesium Hydroxide Passivation Layer” Energies 2015, 8, 4237-4252; in S. D. Kushch et al. “Hydrogen-generating compositions based on magnesium” International Journal of Hydrogen Energy, Volume 36, Issue 1, 2011, Pages 1321-1325; and in T. Tayeh, et al. “Production of hydrogen from magnesium hydrides hydrolysis” International Journal of Hydrogen Energy, Volume 39, Issue 7, 2014, Pages 3109-3117. T. Tayeh et al. discusses the reaction kinetics as a function of particle size and pH value. S. D. Kushch describes the production of hydrogen by means of high-purity magnesium or magnesium hybrid in combination with glycolic acid, malonic acid or citric acid. In addition, Takehito Hiraki, et al. “Chemical equilibrium analysis for hydrolysis of magnesium hydride to generate hydrogen” International Journal of Hydrogen Energy, Volume 37, Issue 17, 2012, Pages 12114-12119, describes the effect of various pH-lowering liquids on the reaction kinetics of the hydrolysis reaction.

The mixing of the base material in the round-bottomed flask with the pH-lowering liquid results in the formation of hydrogen. In the previous test setups, this generated hydrogen is measured batchwise, gravimetrically by means of a displacement vessel. However, it is not possible to continuously convert base material or generate hydrogen. This is not possible with the existing test setups, also due to the expected heat development in the round-bottomed flask due to the strongly exothermic reaction. In addition, the previously known experimental setups must be disadvantageously opened to add additional reactants.

The object of the present invention is to alleviate or eliminate one or more of the drawbacks of the state of the art. In particular, it is an object of the invention to provide a method and a device by means of which hydrogen can be produced continuously from a magnesium-containing base material and a carrier fluid and further additives.

This is achieved by a method for producing hydrogen, comprising the steps of:
providing a base material comprising magnesium;
providing a carrier fluid, in particular water;
providing a pH-lowering liquid;
bringing together the base material and the carrier fluid in a suspension container to form a suspension;
supplying the pH-lowering liquid to a reactor;
continuously supplying the suspension to the reactor;
discharging the hydrogen produced in the reactor during a reaction of the base material and the pH-lowering liquid from the reactor.

Furthermore, this is achieved by a device for the production of hydrogen, comprising:
a suspension container comprising a suspension of a base material comprising magnesium and a carrier fluid, in particular water;
a base material conveying element for supplying base material to the suspension container;
a carrier fluid conveying element for supplying carrier fluid to the suspension container
a storage container comprising a pH-lowering liquid;
a reactor;
a suspension conveying element adapted to continuously supply the suspension from the suspension container to the reactor;
an acid conveying element configured to supply the pH-lowering liquid to the reactor;
wherein the reactor comprises a gas outlet for the hydrogen formed in the reactor during a reaction of the base material and the pH-lowering liquid.

Advantageously, the base material is thus already mixed with the carrier fluid in a suspension container in order to form a suspension. As a result, on the one hand, the base material can be dosed much better. Alternatively, the base material could be dosed in the form of a solid—this would be possible in principle, but is associated with an increased effort with regard to the safety equipment, in particular the tightness. A reaction in the suspension container is only to be expected to a small extent, since a passivation layer is formed with the carrier fluid, and further reactions are prevented. The carrier fluid preferably comprises additives (e.g. oils and/or solid additives) that can prevent a reaction. On the other hand, the base material and the magnesium in the form of the suspension can thus be supplied simultaneously to the reactor in a simple manner. By continuously supplying the suspension to the reactor, the continuous reaction and thus the continuous production of hydrogen is made possible. In the reactor, the suspension and the pH-lowering liquid are mixed and hydrogen is formed.

The carrier fluid (or fluid) comprises, in particular, water or is water. The carrier fluid (as reactant) preferably comprises deionised water or is deionised water.

Alternatively, tap water or seawater, for example, can also be used. For example, the following can be used as reactant carrier fluid:
Tap water, with a pH value of preferably between 6.5 and 8.5, particularly preferably between 7 and 7.5;
Deionised water with a pH value of preferably between 6.8 and 7.5;
Seawater with a pH value of preferably between 7.5 and 8.5, particularly preferably between 7.8 and 8.2.

Preferably, the carrier fluid comprises a pH value of greater than 7. It is generally beneficial for the reaction if the pH value is slightly acidic, as this dissolves any passivation layer that may arise better than carrier fluid/water with a pH value in the slightly basic range.

The base material (in particular the magnesium, the magnesium alloy or the secondary magnesium alloy) has a particle size of preferably between 50 and 1200 μm, particularly preferably between 150 and 600 μm, even more preferably between 200 and 350 μm.

The particle size is preferably understood to be the average particle size. The average particle size denotes the D50 value of the particle size distribution. The D50 value denotes the value below which 50% of the particle size distribution is located. Analogously, a D10 and a D90 value can also be determined as the values below which 10% and 90% of the particle size distribution, respectively, are located. The range is a measure of the width of the particle size distribution and can be determined as range=(D90−D10)/D50.

In connection with the present invention, the particle size distribution, in particular the D50, D10, and D90 values, is preferably determined by laser diffraction particle size analysis. The particle size preferably corresponds to the equivalent diameter of the sphere with the same diffraction. The average particle size preferably corresponds to the volume-based average particle size, in particular the D50 value of a volumetric particle size distribution. Preferably, the laser diffraction particle size analysis is performed according to the ISO 13320:2020 standard.

Alternatively, the average particle size can also be determined by sieve analysis. The person skilled in the art is familiar with carrying out such an analysis. Preferably, the sieve analysis is carried out in accordance with the German standard DIN 66165-1:2016 08.

The reactor is preferably a glass or plastic reactor. These are preferred due to corrosion resistance to acids. The reactor preferably comprises at least one inlet. Preferably, the suspension and the pH-lowering liquid are not supplied to the reactor through the same inlet. That is, preferably, the suspension is supplied to the reactor through a first inlet and the pH-lowering liquid is supplied to the reactor through a second inlet (separate from the first inlet). Preferably, a line is provided that connects the suspension container with the reactor. Preferably, a line is provided that connects the storage container to the reactor. Preferably, a base material container is provided, which preferably comprises the base material. Preferably, the base material conveying element is adapted to supply base material from the base material container to the suspension container. Preferably, a carrier fluid container is provided, which preferably comprises carrier fluid. Preferably, the carrier fluid conveying element is configured to supply carrier fluid from the carrier fluid container to the suspension container. Preferably, the suspension container is connected with the reactor via a line. Preferably, the storage container is connected with the reactor via a line. Preferably, the hydrogen obtained is directly reused, for example for electricity generation. Alternatively, a hydrogen collection vessel is provided for collecting the hydrogen discharged from the gas outlet of the reactor.

The reactor is preferably a continuous stirred reactor (CSR) and preferably comprises a stirring vessel. The reactor comprises a free volume of preferably greater than 1 litre, particularly preferably greater than 5 litres. The reaction in the reactor takes place at an overpressure of preferably at least 0 barg, particularly preferably at an overpressure of 0.5 barg and/or at an overpressure of preferably less than 10 barg, particularly preferably less than 3 barg, even more preferably less than 1 barg. The base material, in particular magnesium, is preferably not present in hydrogenated form.

The base material conveying element preferably comprises a pump. The carrier fluid conveying element preferably comprises a pump, in particular a preferably rotational speed-controlled conveying pump. The carrier fluid container preferably comprises a fill level sensor, which measures the fill level of the carrier fluid in the carrier fluid container. The carrier fluid container preferably comprises a weighing unit and/or an outlet valve. The suspension conveying element preferably comprises a pump, in particular a preferably rotational speed-controlled peristaltic pump. The suspension container preferably comprises an in particular rotational speed-controlled stirrer for stirring the suspension in the suspension container. The carrier fluid and the base material can be mixed with the stirrer. Thus, a homogeneous mixing of the carrier fluid of the reactant with the reactant base material, both then referred to as a suspension, can be ensured. The stirrer, in particular the rotational speed-controlled stirrer, can be operated at a constant speed. The rotational speed of the stirrer is preferably between 30 and 600 min⁻¹, particularly preferably between 200 and 600 min⁻¹, particularly preferably between 250 and 400 min⁻¹. The suspension container preferably comprises a fill level sensor for measuring a fill level of the suspension in the suspension container and/or a weighing unit for weighing the suspension in the suspension container and/or an outlet valve. The acid conveying element preferably comprises a pump, in particular a conveying pump preferably with a motor and/or a rotational speed controller. The storage container preferably comprises a fill level sensor, which measures the fill level of the storage container. The storage container preferably comprises a weighing unit. The storage container preferably comprises an outlet valve. An (acid) temperature sensor is preferably provided, which can measure a temperature of the pH-lowering liquid in the storage container and/or in the acid-conveying element. The pH-lowering liquid preferably comprises an acid. The reactor preferably comprises an input temperature sensor for measuring the temperature of supplied material, an output temperature sensor for measuring the temperature of discharged material, a reactor temperature sensor for measuring the temperature in the reactor, a fill level sensor, a pH value measuring sensor and/or a pressure relief valve, in particular an electrically controlled pressure relief valve and/or a bursting disc.

It is advantageous if the supplying of the pH-lowering liquid to the reactor takes place continuously. This improves the continuous production of hydrogen with a simultaneous continuous supply of the base material. In contrast to the state of the art, no alternating feeding and sealing is necessary.

It is preferred if the method further comprises the step of:
stirring the suspension and the pH-lowering liquid in the reactor with a reactor mixer, wherein the stirring is preferably carried out continuously and wherein a rotational speed of the reactor mixer is preferably constant. The reactor mixer is preferably a rotational speed-controlled stirrer, in particular. The reactor mixer preferably stirs continuously (in particular without interruption) and/or at a constant rotational speed. The reactor mixer is used to mix the suspension with the pH-lowering liquid and to ensure that the chemical reaction is fully implemented in the reactor. The stirrer preferably stirs with a base rotational speed of at least 100 min⁻¹, particularly preferably at least 200 min⁻¹. If a mass flow of the discharged hydrogen falls below a certain mass flow setpoint, the rotational speed of the stirrer can be increased, preferably to a rotational speed between 300 and 550 min⁻¹, particularly preferably to a rotational speed between 350 and 425 min⁻¹.

It is advantageous for a rotational speed of the reactor mixer to be controlled so that the reaction of the base material and the pH-lowering liquid to hydrogen proceeds at a predetermined reaction rate. Preferably, the reaction rate is determined via the measured hydrogen flow discharged from the reactor, i.e., in particular, the reaction rate defines the hydrogen flow and the stirring speed of the reactor mixer.

It is advantageous if the method further comprises the step of:
determining a mass flow of the hydrogen exited from the reactor. This makes it possible to regulate the reaction as a function of the mass flow of the hydrogen. It is preferably a mass flow meter for determining the gas that exited from the gas outlet of the reactor and/or a hydrogen gas purity sensor for determining the hydrogen content of gas that exited from the gas outlet of the reactor. Preferably, the gas outlet of the reactor comprises a condensate separator, which is intended in particular to remove water molecules. Preferably, the gas outlet of the reactor comprises a particle filter, which in particular is connected downstream of the condensate separator. The particle filter is configured in particular for separating solid particles from the gas stream.

It is advantageous if the mass flow of the hydrogen exited from the reactor is controlled at least by adjusting the supply of the suspension to the reactor according to a mass flow setpoint. Preferably, a control loop is provided, wherein the mass flow of the hydrogen exited from the reactor represents the measured variable or the controlled variable, the amount (i.e. the mass flow) of supplied suspension represents the command variable, and a mass flow setpoint represents the reference variable. The mass flow setpoint does not have to be a constant, but can be changed (especially over time). Preferably, however, the mass flow setpoint is constant at least over a time interval. The amount of suspension supplied can be adjusted, in particular, with the rotational speed of the suspension conveying element.

It is advantageous if the supply of the pH-lowering liquid is controlled as a function of the supply of the suspension. The amount (mass) of pH-lowering liquid supplied is preferably directly proportional to the amount (mass) of suspension supplied. There is preferably a certain factor that is directly proportional to the mass flow of the suspension.

It is preferable if heat generated in the reactor during the reaction is dissipated. Preferably, a temperature of a vessel wall of the reactor is regulated, for which purpose cooling fluid is preferably supplied to the vessel wall by means of a heat exchanger and, in particular, an inlet temperature and/or an outlet temperature of the heat exchanger is measured and/or represents the measured variable of the temperature regulation. A temperature setpoint represents, in particular, the command variable. The temperature setpoint is preferably between 45° C. and 85° C., particularly preferably between 50° C. and 80° C., even more preferably between 55° C. and 70° C. The cooling fluid supply represents in particular the controlled variable. This allows the heat of the exothermic reaction to be dissipated.

Preferably, the method further comprises the step of:
separating (in particular liquid and/or solid) residues from the reactor, in particular by means of an immersion tube in the reactor. The separated residue comprises (at least partially) fully reacted base material and pH-lowering liquid. These are in particular dissolved, i.e. the separated residue preferably contains (almost) no solid particles. The immersion tube has the function of conducting liquid out of the reactor. The reactor-side end of the immersion tube is arranged in particular below the gas space in the reactor.

Advantageously, the method further comprises the step of:
recycling the residual material into the reactor. Alternatively, the following step may be provided: Supplying the residual material to a waste container. The fill level in the waste container can be detected with a residual material fill level meter. Preferably, a recirculation is provided in order to supply the pH-lowering liquid and the (partially fully reacted) base material back to the reactor. This allows these substances to be fed back into the reactor in order to be available again as reactants. The recycling rate is preferably between 0% and 50% of the total mass flow of suspension and pH-lowering liquid introduced.

It is advantageous if the method further comprises the step of:
Stirring the base material and the carrier fluid in the suspension container, in particular with a rotational speed-controlled stirrer.

This ensures a homogeneous mixing of the reactant carrier fluid with the reactant base material.

It is advantageous for a fill level of the suspension in the suspension container to be determined (in particular repeatedly or continuously) and for base material and/or carrier fluid to be supplied to the suspension container as a function of the fill level of the suspension determined, in particular when the fill level falls below a defined fill level limit value. This can subsequently ensure a constant supply of suspension to the reactor.

It is advantageous if the suspension is supplied to the reactor via a flooding 3/2-way valve, wherein a water line for flooding the reactor is connected to the flooding 3/2-way valve. Thus, in the event of a fault, the reactor can be flooded with water (or another fluid), so that the reaction comes to a standstill. A 3/2-way valve is understood to be a valve with (at least) three connections and two switching positions.

It is advantageous if the pH-lowering liquid comprises:
Citric acid in a concentration of between 6.4 and 32.0 percent by weight,
Acetic acid in a concentration of between 9.5 and 47.6 percent by weight,
Sulfuric acid in a concentration of between 4.3 and 21.9 percent by weight,
Hydrochloric acid in a concentration of between 5.0 and 25.0 percent by weight, or
Phosphoric acid in a concentration of between 2.9 and 14.4 percent by weight. The specifications in each case refer to 100% acidity. By diluting the acid, a weakening of the reaction kinetics can be achieved, so that the reaction can be better controlled.

These values have shown particularly good conversion rates to hydrogen in experiments. In particular, the acid concentration or how many protons the acid contains, i.e. the substance concentration (in mol/l), is decisive for the reaction. The complete reaction of acid with the base material has a defined stoichiometric need. The pH-lowering liquid is preferably supplied super-stoichiometrically, for example in a ratio of pH-lowering liquid to base material of between 2:1 and 5:1 (pH-lowering liquid:base material).

It is preferred if the percentile value d90 of the grain size of the magnesium of the base material is between 50 and 1200 μm, preferably between 150 and 600 μm, more preferably between 200 and 350 μm. d90 indicates the size below which 90% of the particles lie. This is preferably determined in accordance with DIN 66141:1974-02 or DIN 66161.

It is advantageous if the base material comprises:
AZ91, AS31, AM50, AM60, in particular in pure form; and/or
more than 90 percent by weight of magnesium, preferably more than 95 percent by weight of magnesium, more preferably more than 99 percent by weight of magnesium; and/or
between 10 and 99.5 percent by weight, preferably between 20 and 85 percent by weight, of a magnesium alloy.

It is advantageous if a secondary raw material is used as the magnesium of the base material. This means that magnesium alloys are used that have already undergone a recycling or treatment process.

With reference to the device according to the invention, it is advantageous if it comprises a reactor mixer for stirring the suspension and the pH-lowering liquid in the reactor.

It is advantageous if a mass flow meter for measuring a mass flow of the hydrogen is connected with the gas outlet of the reactor.

Advantageously, the device comprises a control unit configured to carry out the method according to any one of the embodiments described herein.

A heat exchanger system with a heat exchanger is preferably provided, which is configured to cool a vessel wall of the reactor with a cooling fluid, wherein an inflow temperature sensor for measuring an inflow temperature of the cooling fluid to the heat exchanger and/or an outflow temperature sensor for measuring an outflow temperature of the cooling fluid from the heat exchanger are preferably provided.

It is advantageous if the reactor has an outlet, in particular with an immersion tube, for draining residual material from the reactor, wherein the outlet is connected to a recycle 3/2-way valve, wherein the residual material 3/2-way valve is connected to a recycle line for recycling the pH-lowering liquid to the reactor, and is connected with a waste container.

It is advantageous if the suspension conveying element comprises a flooding 3/2-way valve to which a water line for flooding the reactor is connected.

The invention is explained in more detail below with reference to a preferred embodiment shown in the figure, to which the invention is not limited, however.

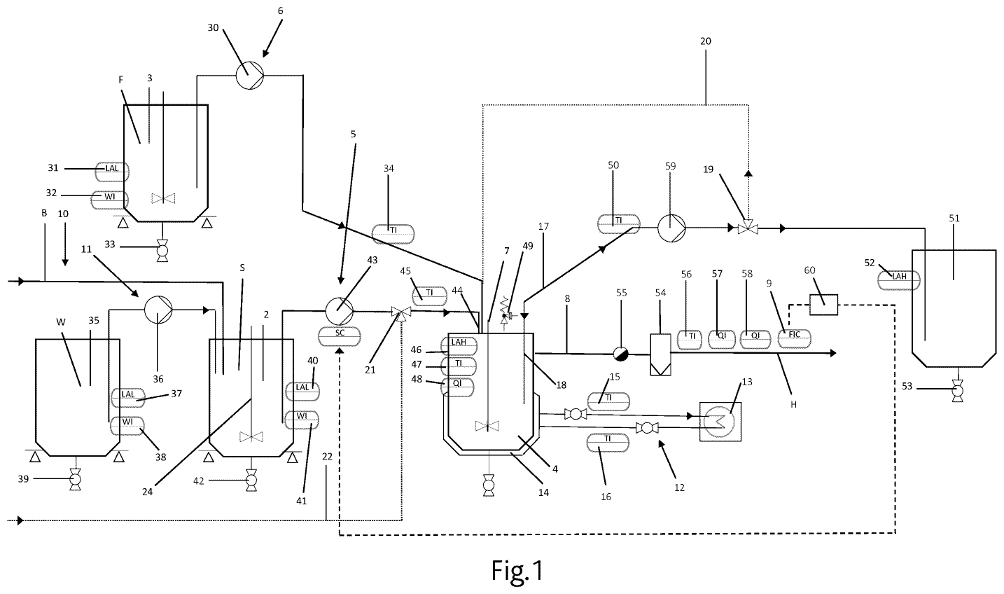

FIG. 1 schematically shows a preferred embodiment of the device for producing hydrogen.

FIG. 1 schematically shows a preferred embodiment of the device 1 for the production of hydrogen H. (H is used as the reference symbol for hydrogen, i.e. H₂). The device comprises:
a suspension container 2 comprising a suspension S of a base material B comprising magnesium and a carrier fluid W (in particular water);
a base material conveying element 10 for supplying base material B to the suspension container 2 (wherein a manual supply may also be provided instead of the base material conveying element 10);
a carrier fluid conveying element 11 for supplying carrier fluid W to the suspension container 2;
a storage container 3 having a pH-lowering liquid F;
a reactor 4, wherein the reactor 4 comprises a gas outlet 8 for the hydrogen H formed in the reactor 4 during a reaction of suspension S and the pH-lowering liquid F;
a suspension conveying element 5 adapted to continuously supply the suspension S from the suspension container 2 to the reactor 4;
an acid conveying element 6 configured to supply the pH-lowering liquid F to the reactor 4.

The acid conveying element 6 has a conveying pump 30 with a motor and a rotational speed controller. The storage container 3 comprises an acid level sensor 31 for measuring a level of the pH-lowering liquid F in the storage container 3, an acid weighing unit 32 for weighing the pH-lowering liquid F in the storage container 3, and an outlet valve 33. An acid temperature sensor 34 is provided, which measures the temperature of the pH-lowering liquid F conducted by the acid conveying element 6.

The device 1 comprises a carrier fluid container 35 for holding carrier fluid W. The carrier fluid conveying element 11 is configured to supply carrier fluid W from the carrier fluid container 35 to the suspension container 2. The carrier fluid conveying element 11 has a rotational speed-controlled conveying pump 36. The carrier fluid container 35 has a carrier fluid fill level sensor 37 for measuring a fill level of the carrier fluid W in the carrier fluid container 35, a carrier fluid weighing unit 38 for weighing the carrier fluid W in the carrier fluid container 35, and an outlet valve 39.

The device 1 may also include a base material container for stocking base material B, but is not shown in this embodiment. The base material conveying element 10 is then configured to supply base material B from the base material container to the suspension container.

The suspension container 2 comprises a speed-controlled stirrer 24, a suspension filling level sensor 40 for measuring a filling level of the suspension S in the suspension container 2, a suspension weighing unit 41, and an outlet valve 42. The suspension conveying element 5 comprises a rotational speed-controlled peristaltic pump 43. Furthermore, the suspension conveying element 5 comprises a flooding 3/2-way valve 21 to which a water line 22 for flooding the reactor 4 is connected. The suspension conveying element 5, and thus also the flooding 3/2-way valve 21, are connected to an inlet 44 of the reactor 4.

In particular, a rotational speed-controlled reactor mixer 7 is provided for stirring the suspension S and the pH-lowering liquid F in the reactor 4, and an inlet temperature sensor 45 is provided for measuring the temperature of the suspension S fed to the reactor 4 at the inlet 44. The reactor also comprises a reactor fill level sensor 46, a reactor temperature sensor 47 for measuring a temperature in the reactor 4, a pH value measuring sensor 48 for measuring a pH value in the reactor 4, and a pressure relief valve 49 (as well as a pressure measurement).

A heat exchanger system 12 with a heat exchanger 13 is provided. The heat exchanger system 12 is configured to cool a vessel wall 14 of the reactor 4 with a cooling fluid. For this purpose, an inlet temperature sensor 15 is provided for measuring an inlet temperature of the cooling fluid to the heat exchanger 13, and an outlet temperature sensor 16 is provided for measuring an outlet temperature of the cooling fluid from the heat exchanger 13.

The reactor has an outlet 17 with an immersion tube 18 for draining residual material from the reactor 4. The outlet 17 is connected to a rotational speed-controlled conveying pump 59 and to a residual material 3/2-way valve 19, wherein the residual material 3/2-way valve 19 is connected to a recycle line 20 for recycling residual material to the reactor 4. Alternatively, the residual material can be supplied via the residual material 3/2-way valve to the waste container 51, which comprises a residual material fill level sensor 52 for measuring a fill level of the residual material in the waste container 51 and an outlet valve 53. A recycle temperature sensor 50 is provided for measuring residual material discharged from the reactor 4.

The gas outlet 8 is connected to a condensate separator 55, a particle separator 54, a hydrogen temperature sensor 56, a hydrogen (H₂) gas purity sensor 57, a carbon dioxide (CO₂) gas purity sensor 58, and a mass flow meter 9 for measuring a mass flow of the hydrogen H.

The operation of the device 1 is described in more detail below. A base material B comprising magnesium is provided (in particular in the base material container). Carrier fluid W is provided in the carrier fluid container 35. With the base material conveying element 10 and the carrier fluid conveying means 11, the base material B and the carrier fluid W are combined in the suspension container 2 to form the suspension S. The base material B and the carrier fluid W are stirred in the suspension container 2 with the stirrer 24 in order to achieve a homogeneous mixture of the carrier fluid W and the base material B to form the suspension S. In particular, the stirrer 24 is operated at a constant rotational speed. By introducing the carrier fluid W directly into the suspension container 2, the base material B can be better dosed. The filling level of the suspension S in the suspension container 2 is determined continuously or repeatedly with the suspension filling level sensor 40. If the measured fill level falls below a defined fill level limit, base material B and carrier fluid W are supplied to the suspension container with the carrier fluid conveying element 11 and the base material conveying element 10.

A pH-lowering liquid F is provided in the storage container 3. In the event of a fault, during servicing or during maintenance, the pH-lowering liquid F can be drained from the storage container 3 via the outlet valve 33 in the storage container 3.

The pH-lowering liquid F is supplied to the reactor 4 by the acid-conveying element 6, in particular continuously, from the storage container 3. The suspension S is continuously supplied from the suspension container 2 to the reactor 4 via the flooding 3/2-way valve 21 with the suspension conveying element 5. The suspension S and the pH-lowering liquid F react in the reactor 4, producing hydrogen (H₂) H (and also residual material and heat). In this way, continuous hydrogen production can be achieved, which is also scalable and without the need for repeated sealing and opening of the reactor 4, as in batchwise operation. The pH-lowering liquid F breaks, in particular, the passivation that forms the suspension S of base material B and carrier fluid W. The reactor mixer 7 preferably runs continuously and mixes the suspension S and the pH-lowering liquid. The reactor mixer 7 thus ensures that the chemical reaction in the reactor 4 can be fully performed. In the event of a fault, the reactor can be flooded with water via the flooding 3/2-way valve 21, so that the reaction is stopped. The pressure relief valve 49 is provided as a further safety device. The pressure relief valve 49 is used as a pressure relief device if the reactor pressure unexpectedly rises above a maximum pressure. In addition, a bursting disk is provided on the reactor 4 as an overpressure safety device.

The hydrogen H produced in the reactor 4 by a reaction of the base material B and the pH-lowering liquid F is discharged from the reactor 4 at the gas outlet 8. With the condensate separator 55, the (fully saturated) hydrogen H is purified from liquid water molecules. Particle filter 54 separates solid particles from the gas stream. Hydrogen gas purity sensor 57 and carbon dioxide gas purity sensor 58 are used to measure the hydrogen and carbon dioxide concentration in the mass flow. This is used as an indicator of the conversion rate of the hydrolysis reaction, in particular the quality of the resulting hydrogen. The mass flow meter 9 is used to determine the mass flow of the hydrogen exited from the reactor 4. A mass flow setpoint is specified and, by adjusting the supply of the suspension S to the reactor, the mass flow of the hydrogen H exited from the reactor 4 is regulated in a control loop to the mass flow setpoint. Furthermore, the supply of the pH-lowering liquid F is controlled as a function of the supply of the suspension S. The mass flow thus is used as control feedback for the supply of the reactants to the reactor.

The residual material with the (at least partially) fully reacted base material is either fed to the waste container 23 or recycled into the reactor 4.

The device 1 also comprises a control unit 60, which is configured to carry out the method (in particular the control loop) with the device 1 as described. The control unit 60 is preferably connected at least with the mass flow meter 9 and the suspension conveying element 5 (e.g., wired or via a wireless connection; shown in dashed lines in FIG. 1).

1: A method for producing hydrogen (H), comprising the steps of:
providing a base material (B) comprising magnesium;
providing a carrier fluid (W), in particular water;
providing a pH-lowering liquid (F);
bringing together the base material (B) and the carrier fluid (W) in a suspension container (2) to form a suspension (S);
supplying the pH-lowering liquid (F) to a reactor (4);
continuously supplying the suspension (S) to the reactor (4); and
discharging the hydrogen (H) produced in the reactor (4) in a reaction of the base material (B) and the pH-lowering liquid (F) from the reactor (4).

2: The method according to claim 1, wherein the supplying of the pH-lowering liquid (F) to the reactor (4) takes place continuously.

3: The method according to claim 1, wherein the method further comprises the step of:
stirring the suspension (S) and the pH-lowering liquid (F) in the reactor (4) with a reactor mixer (7), wherein preferably the stirring is carried out continuously and wherein preferably a rotational speed of the reactor mixer (7) is constant.

4: The method according to claim 3, wherein a rotational speed of the reactor mixer (7) is controlled so that the reaction of the base material (b) and the pH-lowering liquid (F) to hydrogen (H) proceeds at a predetermined reaction rate.

5: The method according to claim 1, further comprising the step of:
determining a mass flow of the hydrogen (H) discharged from the reactor (4).

6: The method according to claim 5, wherein the mass flow of the hydrogen (H) discharged from the reactor (4) is controlled at least by adjusting the supply of the suspension (S) to the reactor (4) according to a mass flow setpoint.

7: The method according to claim 5, wherein the supply of the pH-lowering liquid (F) is controlled as a function of the supply of the suspension (S).

8: The method according to claim 1, wherein heat generated in the reactor (4) during the reaction is dissipated, for which purpose a temperature of a vessel wall (14) of the reactor (4) is preferably controlled, for which purpose cooling fluid is preferably supplied to the vessel wall (14) by means of a heat exchanger (13), and in particular an inlet temperature and/or an outlet temperature of the heat exchanger (13) represents the measured variable of the temperature control.

9: The method according to claim 1, further comprising the steps of:
removing residual material from the reactor (4), in particular by means of an immersion tube (18) in the reactor (4);
recycling the removed residual material into the reactor (4).

10: The method according to claim 1, wherein a fill level of the suspension (S) in the suspension container (2) is determined and a base material (B) and/or carrier fluid (W) are supplied to the suspension container (2) as a function of the determined fill level of the suspension (S), in particular when the fill level falls below a defined fill level limit value.

11: The method according to claim 1, wherein the suspension (S) is supplied to the reactor (4) via a flooding 3/2-way valve (21), wherein a water line (22) for flooding the reactor (4) is connected to the flooding 3/2-way valve (21).

12: A device (1) for producing hydrogen (H) comprising:
a suspension container (2) comprising a suspension (S) of a base material (B) comprising magnesium and a carrier fluid (W), in particular water;
a base material conveying element (10) for supplying base material (B) to the suspension container (2);
a carrier fluid conveying element (11) for supplying carrier fluid (W) to the suspension container (2);
a storage container (3) having a pH-lowering liquid (F);
a reactor (4);
a suspension conveying element (5) configured to continuously supply the suspension (S) from the suspension container (2) to the reactor (4); and
an acid conveying element (6) configured to supply the pH-lowering liquid (F) to the reactor (4);
wherein the reactor (4) comprises a gas outlet (8) for hydrogen (H) formed in the reactor (4) during a reaction of the base material (B) and the pH-lowering liquid (F).

13: The device (1) according to claim 12, wherein a mass flow meter (9) for measuring a mass flow of the hydrogen (W) is connected with the gas outlet (8) of the reactor (4).

14: The device (1) according to claim 12, with a control unit configured to carry out a method to produce hydrogen by providing a base material (B) comprising magnesium; providing a carrier fluid (W), in particular water; providing a pH-lowering liquid (F); bringing together the base material (B) and the carrier fluid (W) in a suspension container (2) to form a suspension (S); supplying the pH-lowering liquid (F) to a reactor (4); continuously supplying the suspension (S) to the reactor (4); and discharging the hydrogen (H) produced in the reactor (4) in a reaction of the base material (B) and the pH-lowering liquid (F) from the reactor (4).

15: The device (1) according to claim 12,
wherein the reactor comprises an outlet (17), in particular with an immersion tube (18), for removing residual material from the reactor (4), wherein the outlet (17) is connected with a residual material 3/2-way valve (19), wherein the residual material 3/2-way valve (19) is connected with a recycle line (20) for recycling the pH-lowering liquid to the reactor (4), and is preferably connected with a waste container (51); and/or
wherein the suspension conveying element (5) comprises a flooding 3/2-way valve (21) to which a water line (22) for flooding the reactor (4) is connected.
